(19) United States
(12) Patent Application Publication
(10) Pub. No.: US 2026/0148456 A1
(43) Pub. Date: May 28, 2026

(54) Image Processing Method and System Neural Network Model Training Method and Medical Imaging System

(71) Applicant: GE Precision Healthcare LLC, Waukesha, WI (US)

(72) Inventors: Xueli Wang, Beijing (CN); Xiaokun Huang, Beijing (CN); Jingting Li, Beijing (CN); Bingjie Zhao, Beijing (CN)

(21) Appl. No.: 19/399,329

(22) Filed: Nov. 24, 2025

(30) Foreign Application Priority Data
Nov. 28, 2024 (CN) 202411729633.6

(51) Int. Cl. G06T 11/00; G06T 3/4046

(52) U.S. Cl. CPC G06T 12/10; G06T 3/4046; G06T 12/20; G06T 2211/421; G06T 2211/441

(57) ABSTRACT

The present disclosure discloses an image processing method and system, a neural network model training method, and a medical imaging system. A method for image processing includes: acquiring raw projection data of a subject under examination, wherein the raw projection data is acquired by scanning the subject under examination by means of a medical imaging system; constructing input features, the input features including trend information of the raw projection data; and using a neural network model to generate enhanced projection data of the subject under examination based on the input features, wherein the enhanced projection data has a higher resolution than the raw projection data and is used to reconstruct a medical image of the subject under examination.

### CROSS-REFERENCE TO RELATED APPLICATIONS

This application claims priority to Chinese Application No. 202411729633.6, filed on Nov. 28, 2024, the disclosure of which is incorporated herein by reference in its entirety.

### TECHNICAL FIELD

The present disclosure relates to the field of image processing, and in particular to an image processing method and system, a neural network model training method, and a medical imaging system.

### BACKGROUND

Imaging techniques allow non-invasive acquisition of images of the internal structure or features of a subject (such as a patient). A digital X-ray imaging system produces digital data that can be reconstructed into radiographic images, such as in computed tomography (CT) or digital breast tomosynthesis (DBT) imaging processes. In a digital X-ray imaging system, radiation from a source is directed toward the subject. A portion of the radiation passes through the subject and impinges on a detector. The detector includes an array of discrete picture elements or detector pixels, and performs processing based on the amount or intensity of radiation impinging on each pixel area to obtain projection data. Complete projection data can be used to reconstruct accurate slice images for diagnosis. These images are used to identify and/or examine internal structures and organs within the patient. The higher the image resolution, the clearer the internal structures and organs can be distinguished, thereby obtaining more accurate diagnostic results.

### SUMMARY OF THE INVENTION

It should be understood that both the foregoing general description and the following detailed description of the present invention are exemplary and illustrative, and are intended to provide further explanation of the present invention as set forth in the claims.

According to a first aspect of the present disclosure, provided is a method for image processing, including: acquiring raw projection data of a subject under examination, wherein the raw projection data is acquired by scanning the subject under examination by means of a medical imaging system; constructing input features, the input features including trend information of the raw projection data; and using a neural network model to generate enhanced projection data of the subject under examination based on the input features, wherein the enhanced projection data has a higher resolution than the raw projection data and is used to reconstruct a medical image of the subject under examination.

In an embodiment, the raw projection data is three-dimensional projection data acquired by a detector of the medical imaging system and includes three dimensions: a row direction, a channel direction, and a viewing angle direction, the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the raw projection data at each of different positions around the subject under examination.

In an embodiment, the trend information of the raw projection data includes one or more of the following: projection data trend information in at least one dimension; and frequency trend information in a specific order obtained by filtering raw projection data at at least one position in the at least one dimension by using at least two kernel functions of different frequencies.

In an embodiment, the trend information of the raw projection data includes projection data trend information presented by a projection data block at at least one position in the at least one dimension, and frequency trend information presented by a filtered projection data block that is obtained by filtering the projection data block by using at least two kernel functions of different frequencies.

In an embodiment, the projection data block includes raw projection data within a plane formed by two other dimensions at a position in one dimension of the at least one dimension of the raw projection data.

In an embodiment, constructing input features includes: constructing the trend information of the raw projection data as input channels of the input features.

In an embodiment, the medical imaging system is a computed tomography (CT) medical imaging system, a positron emission tomography-computed tomography (PET-CT) medical imaging system, or a positron emission tomography (PET) medical imaging system.

According to a second aspect of the present disclosure, provided is a method for training a neural network model, including: acquiring a training data set, the training data set including training raw projection data and training enhanced projection data, wherein the training raw projection data and the training enhanced projection data each are usable for reconstructing a medical image of a subject under examination, the training enhanced projection data has a higher resolution than the training raw projection data, and the training enhanced projection data is used as a ground truth for an output of the neural network model; constructing training input features, the training input features including trend information of the training raw projection data; using the neural network model to generate, based on the training input features, a predicted result of enhanced projection data having a higher resolution than the training raw projection data; calculating a loss function between the predicted result and the ground truth; and updating parameters of the neural network model based on the loss function to obtain a trained neural network model.

In an embodiment, the training raw projection data is three-dimensional projection data acquired by a detector of the medical imaging system and includes three dimensions: a row direction, a channel direction, and a viewing angle direction, the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the training raw projection data at each of different positions around the subject under examination.

In an embodiment, the trend information of the training raw projection data includes one or more of the following: projection data trend information in at least one dimension; and frequency trend information in a specific order obtained by filtering training raw projection data at at least one position in the at least one dimension by using at least two kernel functions of different frequencies.

In an embodiment, constructing training input features includes: constructing the trend information of the training raw projection data as input channels of the training input features.

In an embodiment, the loss function includes at least one of the following: a mean absolute error loss function, a mean structural similarity index measure loss function, and a perceptual loss function.

According to a third aspect of the present disclosure, provided is a system for image processing, including a neural network model, wherein: the neural network model receives trend information of raw projection data acquired by scanning a subject under examination by means of a medical imaging system, uses the trend information as input features, and outputs enhanced projection data, wherein the enhanced projection data has a higher resolution than the raw projection data; and the neural network model includes: a shallow feature extraction layer, configured to perform feature extraction on the input features by using a convolutional layer, so as to obtain shallow features; a deep feature extraction layer, configured to perform feature extraction on the shallow features by using at least one residual group, a convolutional layer, and a summation module that are cascaded, so as to obtain deep features; and an upsampling layer, configured to upsample the deep features into the enhanced projection data.

In an embodiment, each residual group of the deep feature extraction layer includes: a plurality of cascaded residual blocks, each residual block being configured to extract deep features of a different level from an input of the residual group; a concatenation layer, configured to concatenate deep features extracted by all the residual blocks to obtain concatenated deep features; and a convolutional layer, configured to perform a convolution operation on the concatenated deep features to obtain an output of the residual group.

In an embodiment, each residual block includes: a plurality of parallel convolutional layers of different sizes, each convolutional layer being configured to perform a convolution operation on an input of the residual block to obtain a convolution result; a plurality of activation function modules, each activation function module being cascaded with one of the plurality of parallel convolutional layers of different sizes, and configured to apply an activation function to a convolution result of the corresponding convolutional layer to obtain a local feature; a concatenation layer, configured to concatenate local features of the activation function modules to obtain concatenated local features; a final-stage convolutional layer, configured to perform a convolution operation on the concatenated local features to obtain a final-stage convolution result; and a summation module, configured to add the final-stage convolution result to the input of the residual block to obtain an output of the residual block.

In an embodiment, the raw projection data is three-dimensional projection data acquired by a detector of the medical imaging system and includes three dimensions: a row direction, a channel direction, and a viewing angle direction, the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the raw projection data at each of different positions around the subject under examination.

In an embodiment, the trend information of the raw projection data includes one or more of the following: projection data trend information in at least one dimension; and frequency trend information in a specific order obtained by filtering raw projection data at at least one position in the at least one dimension by using at least two kernel functions of different frequencies.

According to a fourth aspect of the present disclosure, provided is a medical imaging system, including: a scanning device, configured to acquire raw projection data of a subject under examination; and a processor, configured to perform the method according to any one of the foregoing aspects.

According to a fifth aspect of the present disclosure, provided is a non-transient computer-readable medium, having instructions stored thereon, wherein the instructions are executable by a processor to implement the method according to any one of the foregoing aspects.

### BRIEF DESCRIPTION OF THE DRAWINGS

The present invention can be better understood by means of the description of the exemplary embodiments of the present invention in conjunction with the drawings, in which:

FIG. 1 shows a schematic diagram of an exemplary CT system configured for CT imaging;

FIG. 2 shows an exemplary imaging system similar to the CT system in FIG. 1;

FIG. 3 shows a schematic diagram of a CT system during patient examination;

FIG. 4 shows a flowchart of an image processing method according to an embodiment of the present disclosure;

FIG. 5 shows a schematic diagram of raw projection data according to an embodiment of the present disclosure;

FIG. 6 shows a schematic diagram of projection data trend information in a viewing angle direction for acquiring raw projection data according to an embodiment of the present disclosure;

FIG. 7 shows a schematic diagram of frequency trend information of raw projection data according to an embodiment of the present disclosure;

FIG. 8 shows a method for performing batch processing within a channel-row plane according to an embodiment of the present disclosure;

FIG. 9 shows a flowchart of a method for training a neural network model according to an embodiment of the present disclosure;

FIG. 10 shows a flowchart of a method for image processing according to another embodiment of the present disclosure;

FIG. 11A to FIG. 11C show schematic diagrams of a neural network model according to an embodiment of the present disclosure;

FIG. 12A to FIG. 12D illustrate comparisons between reconstructed images generated from raw projection data and reconstructed images generated from enhanced projection data; and

FIG. 13 shows an exemplary block diagram of a computing device according to an embodiment of the present disclosure.

In the accompanying drawings, similar components and/or features may have the same numerical reference signs. Further, components of the same type may be distinguished by letters following the reference sign, and the letters may be used for distinguishing between similar components and/or features. If only a first numerical reference sign is used in the specification, the description is applicable to any similar component and/or feature having the same first numerical reference sign irrespective of the subscript of the letter.

### DETAILED DESCRIPTION

Specific implementations of the present invention will be described below. It should be noted that in the specific description of said implementations, for the sake of brevity and conciseness, the present description cannot describe all of the features of the actual implementations in detail. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for those of ordinary skill in the art related to the content disclosed in the present invention, some design, manufacture, or production changes made on the basis of the technical content disclosed in the present disclosure are only common technical means, and should not be construed as the content of the present disclosure being insufficient.

References in the specification to “an embodiment,” “embodiment,” “exemplary embodiment,” and so on indicate that the embodiment described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless defined otherwise, technical terms or scientific terms used in the claims and description should have the usual meanings that are understood by those of ordinary skill in the technical field to which the present invention belongs. The terms “include” or “include” and similar words indicate that an element or object preceding the terms “include” or “include” encompasses elements or objects and equivalent elements thereof listed after the terms “include” or “include”, and do not exclude other elements or objects.

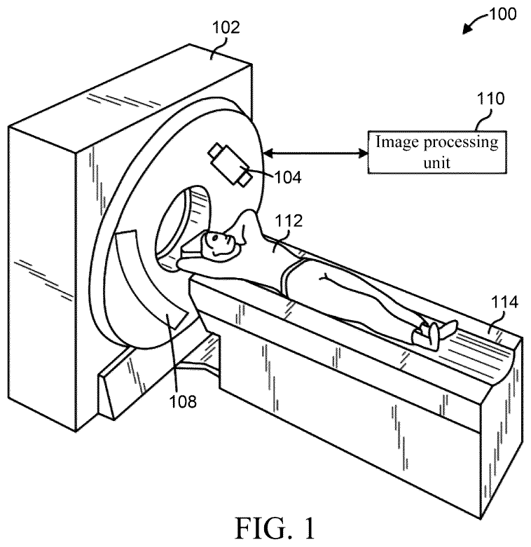

Embodiments of the present disclosure will be described below by way of example with reference to FIG. 1 to FIG. 13. Although a CT system is described by way of example, it should be understood that the techniques of the present disclosure are broadly applicable to various fields of non-destructive examination. The techniques of the present disclosure may also be useful when applied to images acquired by using other imaging modalities, such as X-ray imaging systems, magnetic resonance imaging (MRI) systems, positron emission tomography (PET) imaging systems, single photon emission computed tomography (SPECT) imaging systems, and combinations thereof (e.g., multi-modal imaging systems such as PET/CT, PET/MR, or SPECT/CT imaging systems). Exemplarily, the embodiments of the present disclosure are described below in conjunction with X-ray computed tomography (CT) imaging. Those skilled in the art would appreciate that the embodiments of the present disclosure can also be applied to other medical imaging.

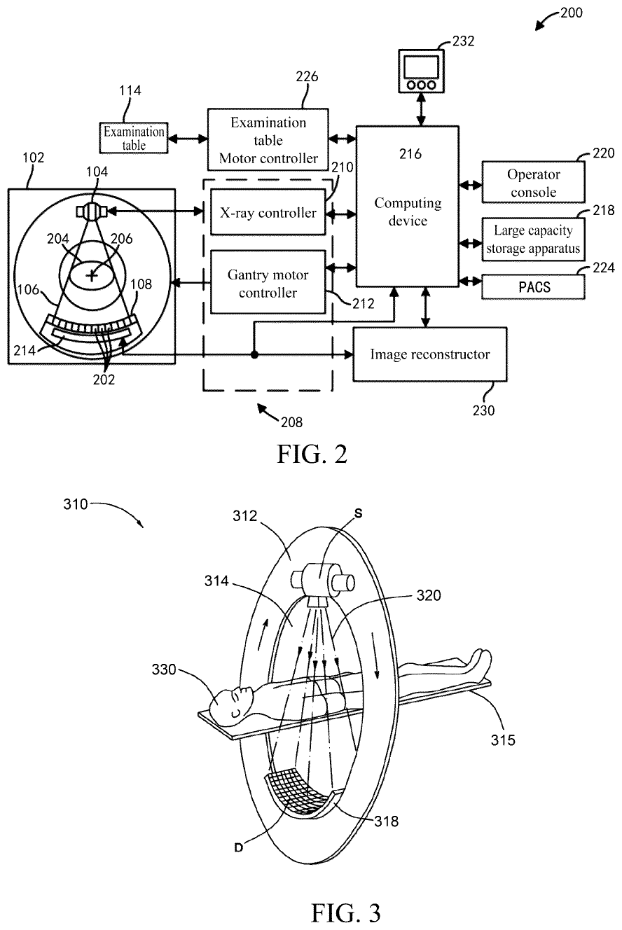

FIG. 1 shows a schematic diagram of an exemplary CT system 100 configured for CT imaging. Specifically, the CT system 100 is configured to image a subject 112 (such as a patient, an inanimate object, or one or more manufactured components) and/or a foreign object (such as a dental implant, a stent, and/or a contrast agent present in the body). In one implementation, the CT system 100 includes a gantry 102, which in turn may further include at least one X-ray source 104. The at least one X-ray source is configured to project an X-ray radiation beam 106 (see FIG. 2) for imaging the subject 112 lying on an examination table 114. Specifically, the X-ray source 104 is configured to project the X-ray radiation beam 106 toward a detector array 108 positioned on the opposite side of the gantry 102. Although FIG. 1 depicts a single X-ray source 104, in certain implementations, a plurality of X-ray sources and detectors may be used to project a plurality of X-ray radiation beams, so as to acquire projection data corresponding to the patient at different energy levels. In some implementations, the X-ray source 104 may enable dual-energy gemstone spectral imaging (GSI) by means of rapid peak kilovoltage (kVp) switching. In some implementations, the X-ray detectors used are photon counting detectors capable of distinguishing X-ray photons of different energies. In other implementations, dual-energy projections are generated using two sets of X-ray sources and detectors, wherein one set of X-ray sources and detectors is set to low kVp and the other set is set to high kVp. It should therefore be understood that the methods described herein may be implemented using single-energy acquisition techniques and dual-energy acquisition techniques.

In certain implementations, the CT system 100 further includes an image processing unit 110, and the image processing unit is configured to reconstruct images of a target volume of the subject 112 by using iterative or analytical image reconstruction methods. For example, the image processing unit 110 may reconstruct images of a target volume of the patient by using analytical image reconstruction methods such as filtered back projection (FBP). As another example, the image processing unit 110 may use iterative image reconstruction methods (such as advanced statistical iterative reconstruction (ASIR), conjugate gradient (CG), maximum likelihood expectation maximization (MLEM), model-based iterative reconstruction (MBIR), etc.) to reconstruct images of a target volume of the subject 112. As further described herein, in some examples, in addition to iterative image reconstruction methods, the image processing unit 110 may further use analytical image reconstruction methods (such as FBP).

In some CT imaging system configurations, the X-ray source projects a conical X-ray radiation beam. The conical X-ray radiation beam is collimated to be located within an X-Y-Z plane of a Cartesian coordinate system, and the plane is usually referred to as the “imaging plane”. The X-ray radiation beam passes through an object being imaged, such as a patient or a subject. After being attenuated by the object, the X-ray radiation beam is incident on an array of detector elements. The intensity of the attenuated X-ray radiation beam received at the detector array depends on the attenuation of the X-ray radiation beam by the object. Each detector element of the array produces a separate electrical signal, the separate electrical signal being a measurement of X-ray beam attenuation at the detector position. Attenuation measurements from all detector elements are individually acquired to generate a transmission distribution.

In some CT systems, a gantry is used to rotate, in the imaging plane, the X-ray source and the detector array around the object to be imaged, so that the angle at which the X-ray beam intersects the object continually changes. A set of X-ray radiation attenuation measurement results (e.g., projection data) from the detector array at a gantry angle is referred to as a “view”. A “scan” of the object includes a set of views made at different gantry angles or viewing angles during a single rotation of the X-ray source and detector. It can be contemplated that benefits of the method in this specification derive from a medical imaging modality other than CT. Therefore, as used herein, the term “view” is not limited to the use described above with respect to projection data from one gantry angle. The term “view” is used to mean one data acquisition when there are a plurality of data acquisitions (acquisitions from CT, positron emission tomography (PET), or single photon emission CT (SPECT)) from different angles, and/or any other modality (including a modality to be developed) and combinations thereof in fused embodiments.

Projection data is processed to reconstruct images corresponding to two-dimensional slices acquired through the object, or, in some examples in which the projection data includes a plurality of views or scans, to reconstruct images corresponding to three-dimensional images of the object. A method for reconstructing an image from a set of projection data is referred to as a filtered back projection technique in the art. Transmission and emission tomography reconstruction techniques also include statistical iterative methods, such as maximum likelihood expectation maximization (MLEM) and ordered subset expectation reconstruction techniques, as well as iterative reconstruction techniques. The method converts an attenuation measurement from a scan into an integer referred to as a “CT number” or “Hounsfield unit”, which is used to control the brightness of a corresponding pixel on a display device.

To reduce the total scan time, a “helical” scan may be performed. To perform the “helical” scan, the patient is moved when data of a specified number of slices is acquired. Such systems produce a single helix from helical scanning of a conical beam. The helix mapped out by the conical beam produces projection data according to which an image in each specified slice can be reconstructed.

As used herein, the phrase “reconstructing an image” is not intended to exclude embodiments in which data representing an image is generated without producing a visual image. Thus, as used herein, the term “image” broadly refers to both a visual image and data representing a visual image. However, many embodiments generate (or are configured to generate) at least one visual image.

FIG. 2 shows an exemplary imaging system 200 similar to the CT system 100 in FIG. 1. According to aspects of the present disclosure, the imaging system 200 is configured to image a subject 204 (e.g., the subject 112 of FIG. 1). In one implementation, the imaging system 200 includes the detector array 108 (see FIG. 1). The detector array 108 further includes a plurality of detector elements 202, which together sense the X-ray radiation beam 106 (see FIG. 2) passing through the subject 204 (such as a patient) to acquire corresponding projection data. Therefore, in one implementation, the detector array 108 is fabricated in a multi-row or multi-line configuration including a plurality of rows or lines of units or detector elements 202. In such a configuration (e.g., multi-row or multi-line detector CT or MDCT), another row or a plurality of rows of detector elements 202 are arranged in a parallel configuration to acquire projection data. The configuration may include 4, 8, 16, 32, 64, 128, or 256 rows or lines of detector elements. For example, a 64-row MDCT scanner may have 64 rows or lines of detector elements, while a 256-row MDCT scanner may have 256 rows or lines of detector elements. Therefore, four rotations of a helical scan performed by a 64-row or 64-line MDCT scanner can achieve a detector coverage equal to a single rotation of a scan performed by a 256-row or 256-line MDCT scanner.

In certain implementations, the imaging system 200 is configured to traverse different angular positions around the subject 204 to acquire required projection data. Therefore, the gantry 102 and components mounted thereon can be configured to rotate about a center of rotation 206 to acquire projection data at different energy levels, for example. Alternatively, in implementations in which the projection angle with respect to the subject 204 changes over time, the mounted components may be configured to move along a generally curved line rather than along a segment of a circular arc.

Therefore, when the X-ray source 104 and the detector array 108 rotate, the detector array 108 collects data of the attenuated X-ray beam. The data collected by the detector array 108 is then subjected to pre-processing and calibration to adjust the data so as to represent line integrals of attenuation coefficients of the scanned subject 204. The processed data is generally referred to as a projection.

In some examples, individual detectors or detector elements 202 in the detector array 108 may include photon counting detectors which register interactions of individual photons into one or more energy bins. It should be understood that the method described herein may also be implemented using an energy integration detector.

An acquired projection data set may be used for base material decomposition (BMD). During the BMD, the measured projection is converted to a set of material density projections. The material density projections may be reconstructed to form one pair or a set of material density maps or images (such as bone, soft tissue, and/or contrast agent maps) of each corresponding base material. The density maps or images may then be correlated to form a 3D volumetric image of the base material (e.g., bone, soft tissue, and/or a contrast agent) in the imaging volume.

Once reconstructed, the base material image produced by the imaging system 200 displays the internal features of the subject 204 represented in terms of the densities of two base materials. The density images can be displayed to demonstrate the foregoing features. In a conventional method for diagnosing medical conditions (such as disease states), and more generally for diagnosing medical events, a radiologist or physician considers a hard copy or display of a density image to discern characteristic features of interest. Such features may include a lesion, size, and shape of a particular anatomical structure or organ, and other features should be discernible in the image on the basis of the skill and knowledge of an individual practitioner.

In one implementation, the imaging system 200 includes a control mechanism 208 to control movement of components, such as the rotation of the gantry 102 and the operation of the X-ray source 104. In certain implementations, the control mechanism 208 further includes an X-ray controller 210, configured to provide power and timing signals to the X-ray source 104. Additionally, the control mechanism 208 includes a gantry motor controller 212, configured to control the rotational speed and/or position of the gantry 102 on the basis of imaging requirements.

In certain implementations, the control mechanism 208 further includes a data acquisition system (DAS) 214, configured to sample analog data received from the detector elements 202, and to convert the analog data into digital signals for subsequent processing. The DAS 214 may further be configured to selectively aggregate analog data from a subset of the detector elements 202 into a so-called macro detector, as described further herein. The data sampled and digitized by the DAS 214 is transmitted to a computer or computing device 216. In an example, the computing device 216 stores data in a storage device or large-capacity storage apparatus 218. For example, the storage device 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In certain embodiments, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows one operator console 220, more than one operator console may be coupled to the imaging system 200, and, for example, is used to input or output system parameters, request examination, map data, and/or view images. Moreover, in certain implementations, the imaging system 200 may be coupled to, for example, a plurality of displays, printers, workstations, and/or similar devices located locally or remotely within an institution or hospital or in a completely different location by means of one or more configurable wired and/or wireless networks (such as the Internet and/or a virtual private network, a wireless telephone network, a wireless local area network, a wired local area network, a wireless wide area network, a wired wide area network, etc.).

In one implementation, for example, the imaging system 200 includes or is coupled to a picture archiving and communication system (PACS) 224. In an exemplary implementation, the PACS 224 is further coupled to a remote system (such as a radiology information system or a hospital information system) and/or coupled to an internal or external network (not shown) to allow an operator at a different position to provide commands and parameters and/or obtain access to image data.

The computing device 216 uses operator-supplied and/or system-defined commands and parameters to operate an examination table motor controller 226, which can in turn control the examination table 114. The examination table may be an electric examination table. Specifically, the examination table motor controller 226 may move the examination table 114 to properly position the subject 204 in the gantry 102, so as to acquire projection data corresponding to a target volume of the subject 204.

As described previously, the DAS 214 samples and digitizes projection data acquired by the detector elements 202. Subsequently, an image reconstructor 230 uses the sampled and digitized X-ray data to perform high-speed reconstruction. Although the image reconstructor 230 is shown as a separate entity in FIG. 2, in certain implementations, the image reconstructor 230 may form a part of the computing device 216. Alternatively, the image reconstructor 230 may not be present in the imaging system 200, and the computing device 216 may instead perform one or more functions of the image reconstructor 230. In addition, the image reconstructor 230 may be located locally or remotely and may be operably connected to the imaging system 200 by using a wired or wireless network. Specifically, in one exemplary embodiment, computing resources in a “cloud” network cluster may be used for the image reconstructor 230.

In one embodiment, the image reconstructor 230 stores a reconstructed image in the storage device 218. Alternatively, the image reconstructor 230 may transmit the reconstructed image to the computing device 216 to generate usable patient information for diagnosis and evaluation. In certain implementations, the computing device 216 may transmit the reconstructed image and/or patient information to a display or display device 232, the display or display device being communicatively coupled to the computing device 216 and/or the image reconstructor 230. In some implementations, the reconstructed image may be transmitted from the computing device 216 or the image reconstructor 230 to the storage device 218 for short-term or long-term storage.

FIG. 3 shows a schematic diagram of a CT system during patient examination. As shown in FIG. 3, the CT system 310 generally includes a rotatable gantry 312 and a support table 315, the support table being disposed in a hollow imaging area 314 of the rotatable gantry 312 and configured to carry a patient 330. The rotatable gantry 312 includes an X-ray source S and a detector 318 disposed opposite to the X-ray source S, wherein the detector 318 includes a plurality of independent detector units D arranged in an array. When the rotatable gantry 312 is located at a certain scanning position, the X-ray source S emits a fan-shaped X-ray beam 320 toward the detector 318, and the plurality of detector units D separately sense X-rays attenuated by the patient 330, so that a set of projection data is obtained by the detector units D through sensing, thereby obtaining a corresponding frame of projection data. As the rotatable gantry 312 rotates, the X-ray source S and the detector 318 rotate around a center of rotation O. The CT system 310 performs multiple scans, and during each scan, all the detector units D may obtain each corresponding frame of projection data through sensing. Under normal operation of the detector units D, each corresponding frame of projection data can be directly used to reconstruct one or more images. A direction of the detector 318 in which a subject under examination moves toward or out of a medical imaging system is referred to as a row direction, that is, a direction in which the subject under examination on the support table 315 moves toward or out of the rotatable gantry 312. An extension direction of the detector 318 arranged locally around the subject under examination, which is perpendicular to the row direction is referred to as a channel direction, that is, a direction in which the detector 318 is arranged in an arc shape along the rotatable gantry 312. The angle at which the detector 318 acquires raw projection data at each of different positions around the subject under examination is referred to as a viewing angle direction, that is, the different angles at which the detector 318 rotates around the subject under examination along the rotatable gantry 312.

To obtain reconstructed images with higher resolution, a new technique has emerged in recent years, wherein the imaging process is improved by means of artificial intelligence. Currently, the main improvement approach is to obtain a high-resolution image on the basis of a low-resolution image. Although this image-to-image approach is relatively simple and intuitive, due to the approach being pixel-to-pixel and the non-interpretability of deep learning networks, defects such as false structures, bridging, or edge overshoot may be generated in the image, which are significant problems for medical imaging. Another improvement approach is to perform predication based on projection data. However, since projection data is the basis of image reconstruction, if the prediction based on the projection data is incorrect, it is easy to produce streak defects in the reconstructed image. Hence, it is very difficult to obtain a high-resolution image by performing prediction based on projection data.

In view of the above problems, implementations of the present disclosure innovatively propose an image processing method and system, a neural network model training method, and a medical imaging system which improve image resolution by using a neural network model and based on projection data.

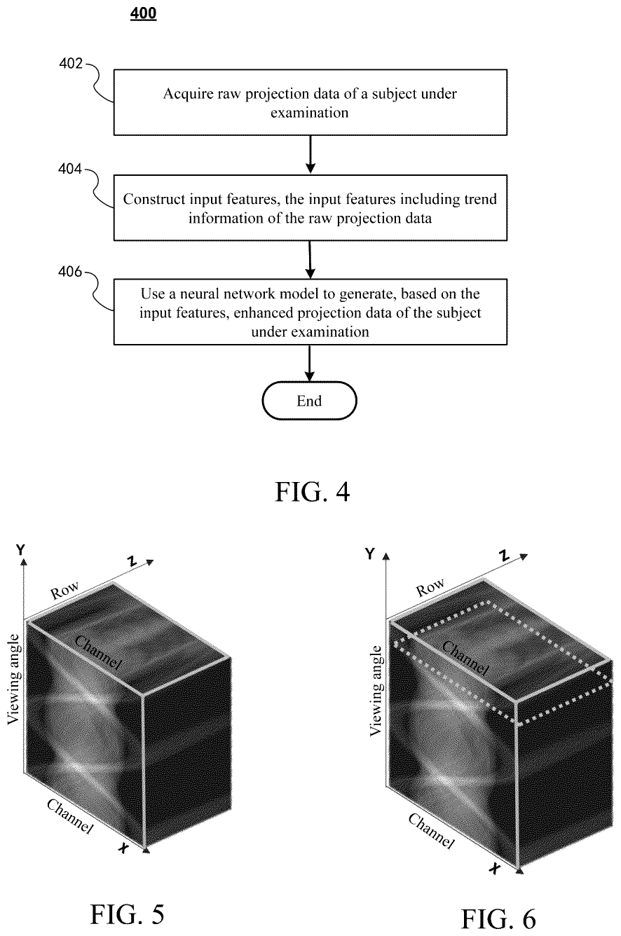

FIG. 4 shows a flowchart of an image processing method 400 according to an embodiment of the present disclosure. In step 402, raw projection data of a subject under examination is acquired, wherein the raw projection data is acquired by scanning the subject under examination by means of a medical imaging system. Next, in step 404, input features are constructed, the input features including trend information of the raw projection data. Then, in step 406, a neural network model is used to generate enhanced projection data of the subject under examination based on the input features, wherein the enhanced projection data has a higher resolution than the raw projection data and is used to reconstruct a medical image of the subject under examination.

FIG. 5 shows a schematic diagram of raw projection data according to an embodiment of the present disclosure. The raw projection data is three-dimensional projection data acquired by a detector of a medical imaging system. For example, the raw projection data is acquired by the detector 108 or 318 of the CT system 100, 200, or 310 described in FIG. 1 to FIG. 3. In an embodiment, the medical imaging system may be a computed tomography (CT) medical imaging system, a positron emission tomography-computed tomography (PET-CT) medical imaging system, or a positron emission tomography (PET) medical imaging system. The raw projection data includes three dimensions: a row direction (Z direction), a channel direction (X direction), and a viewing angle direction (Y direction). The row direction (Z direction) indicates a direction of the detector in which the subject under examination moves toward or out of the medical imaging system, i.e., a scanning translation direction of the medical imaging system. For example, the detector 108 or 318 of the CT system 100, 200, or 310 may be configured with different numbers of rows of detector units in the row direction (Z direction), for example, may include 8 rows, 16 rows, 32 rows, 64 rows, 256 rows, 512 rows, and the like. The channel direction (X direction) indicates an extension direction of the detector arranged locally around the subject under examination, which is perpendicular to the row direction, i.e., a width direction of the detector 108 or 318 of the medical imaging system. For example, there may be about 900 channels. The viewing angle direction (Y direction) indicates an angle at which the detector acquires raw projection data at each of different positions around the subject under examination, for example, the angle or viewing angle at which the detector 108 or 318 rotates along with the gantry when the CT system 100, 200, or 310 described in the FIG. 1 to FIG. 3 acquires a view. For example, in an axial scan, the medical imaging system may acquire raw projection data or views at about 1000 angular positions, one angular position being referred to as one viewing angle.

Trend information refers to the trend of variation of information presented or included in the raw projection data or in data obtained by processing the raw projection data. The trend information of the raw projection data may include information about structures or attributes of the subject under examination covered by the raw projection data acquired by the detector of the medical imaging system (e.g., the detector 108 or 318 of the CT system 100, 200, or 310). For example, since tissue information within human organs constantly changes across different locations and has correlation, after an organ of the human body is scanned, data points in the acquired raw projection data exhibit variation trends in the row direction, the channel direction, and the viewing angle direction, that is, information presented or included in the projection data itself.

In addition to the projection data itself, a difference between projection data at two adjacent viewing angle positions in the viewing angle direction includes or presents structural difference information of the subject under examination at the adjacent viewing angle positions, such as the residual boundaries of anatomical tissues presented in the projection data. Therefore, the difference data between the projection data at the two adjacent viewing angle positions in the viewing angle direction can also reflect the trend information.

The trend information of the raw projection data may further include trend information presented by data obtained after the raw projection data is processed. For example, in CT image processing, a kernel function or a convolution kernel is an important parameter for image reconstruction, which mainly affects the sharpness and noise level of an image by adjusting the frequency content of projection data. Different types of kernel functions may be used for different anatomical structures, for example, a bone kernel may improve the spatial resolution of bones, while a soft tissue kernel is suitable for soft tissue imaging. In a tomographic image acquired by the medical imaging system, different soft tissues and high-frequency tissues usually simultaneously exist, for example, lungs and vertebra, heart and vertebra, liver and vertebra, brain soft tissue and skull, etc. Different tissues correspond to different kernel functions, and different kernel functions have different cut-off frequencies and enhancement functions. If an operator wants to clearly observe information about different frequencies of different organs or tissues, it is necessary to filter the projection data with different kernel functions to obtain projection data enhanced at different frequencies. Accordingly, the raw projection data is filtered by using kernel functions of different frequencies, and the generated filtered data corresponding to different kernel functions can reflect information about trends of frequency variation, that is, frequency trend information.

In addition, the trend information of the raw projection data may further include the input order when the acquired trend information is input into the neural network model in a specific order. For example, when the raw projection data is filtered by using the kernel functions of different frequencies, the filtered data may be input into the neural network model in ascending or descending order of frequency. Therefore, this processing manner also reflects sequential trend information.

The present disclosure innovatively proposes using trend information of projection data to construct input features in order to enhance the resolution of raw projection data. Generally, during image reconstruction, a large number of projection data points must be processed through inference, and even a single inference error may result in generation of easily recognizable defects such as streaks in the reconstructed image. Therefore, when projection data is used for image enhancement, a higher inference accuracy is required. In the present disclosure, by using one or more types of trend information, when the neural network model performs prediction, more accurate prediction can be made by referring to the trend information of the projection data itself and/or the trend information presented by data obtained after the raw projection data is processed.

In an embodiment, in step 404, constructing the input features may include: constructing the trend information of the raw projection data as input channels of the input features. It is understood that the “input channels” of the input features correspond to the concept of describing the dimensionality of features in artificial intelligence, while the “channel direction” of the projection data corresponds to the extension direction of the detector of the medical imaging system, the detector being arranged locally around the subject under examination.

In an embodiment, the trend information of the raw projection data may include projection data trend information in at least one dimension.

In an embodiment, the trend information of the raw projection data may include projection data trend information in the row direction and the channel direction. As an example, when the input features are constructed based on the projection data trend information in the row direction (Z direction) and the channel direction (X direction), raw projection data within a plane formed by the row direction and the channel direction at a viewing angle position in the viewing angle direction of the raw projection data may be constructed as an input channel of the input features. For example, a data block corresponding to the top box shown in FIG. 5 may be constructed as an input channel of the input features.

In an embodiment, the trend information of the raw projection data may include projection data trend information in the viewing angle direction. For example, the trend information of the raw projection data may include projection data trend information about a difference between a projection data block of the raw projection data at a viewing angle position and a projection data block of the raw projection data at an adjacent viewing angle position. As an example, when the input features are constructed based on the trend information in the viewing angle direction (Y direction), a difference can be calculated between a data block of the raw projection data within a plane formed by the row direction and the channel direction at a viewing angle position in the viewing angle direction and a data block of the raw projection data within a plane formed by the row direction and the channel direction at an adjacent viewing angle position in the viewing angle direction, and said difference is constructed as an input channel of the input features. FIG. 6 shows a schematic diagram of projection data trend information in a viewing angle direction for acquiring raw projection data according to an embodiment of the present disclosure. For a data block corresponding to the top solid-line box, a difference can be calculated between said data block and a data block represented by the dashed-line box at an adjacent viewing angle position. Accordingly, the difference may be constructed as an input channel of the input features.

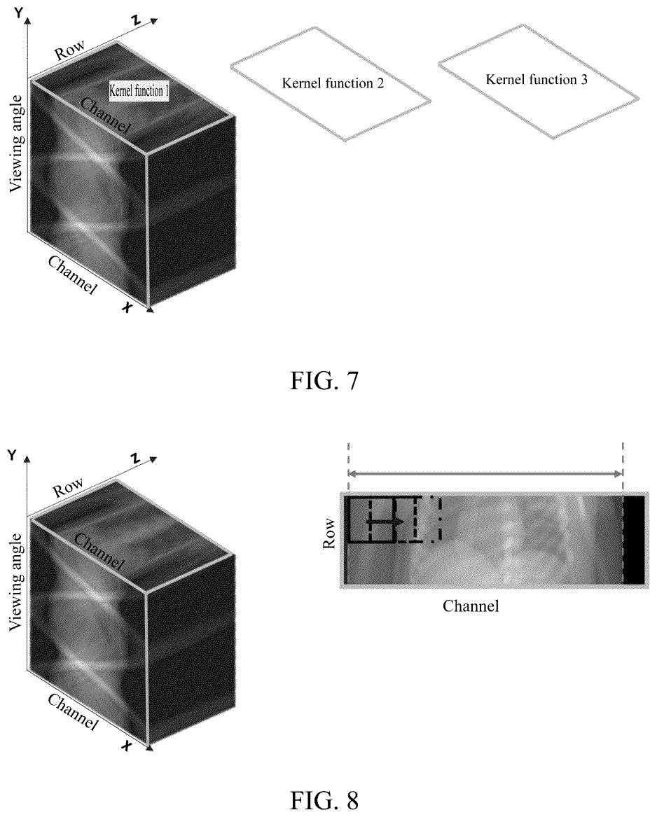

In an embodiment, the trend information of the raw projection data may include frequency trend information in a specific order obtained by filtering raw projection data at at least one position in at least one dimension by using at least two kernel functions of different frequencies. FIG. 7 shows a schematic diagram of frequency trend information of raw projection data according to an embodiment of the present disclosure. In a tomographic image acquired by the medical imaging system, different soft tissues and high-frequency tissues usually simultaneously exist, for example, lungs and vertebra, heart and vertebra, liver and vertebra, brain soft tissue and skull, etc. Different tissues correspond to different kernel functions, and different kernel functions have different cut-off frequencies and enhancement functions. If an operator wants to clearly observe information about different frequencies of different organs or tissues, it is necessary to filter the projection data with different kernel functions to obtain projection data enhanced at different frequencies. Accordingly, the projection data enhanced by using different frequencies can also reflect variation trends in the sharpness of the data. As shown in the figure, for a data block of the raw projection data within a plane formed by the row direction and the channel direction at a viewing angle position in the viewing angle direction, said data block may be separately filtered using a kernel function 1, a kernel function 2, and a kernel function 3 of different frequencies. If the data block contains tissue corresponding to high frequency, the tissue will have gradually varying sharpness after being processed by the kernel functions of different frequencies. As an example, when the input features are constructed based on the frequency trend information, filtered data blocks obtained by filtering, by using the kernel functions of different frequencies, the data block of the raw projection data within the plane formed by the row direction and the channel direction at a viewing angle position in the viewing angle direction may each be constructed as an input channel of the input features according to the frequency variation order of the kernel functions. For example, when there are three kernel functions, a first filtered data block, a second filtered data block, and a third filtered data block can be constructed as three input channels of the input features in the order of increasing or decreasing cut-off frequency of the three kernel functions. For example, the first filtered data block obtained by performing filtering using a first kernel function having the highest cut-off frequency is used as a first input channel of the input features, the second filtered data block obtained by performing filtering using a second kernel function having a medium cut-off frequency is used as a second input channel of the input features, and the third filtered data block obtained by performing filtering using a third kernel function having the lowest cut-off frequency is used as a third input channel of the input features.

In an embodiment, the trend information of the raw projection data may include projection data trend information presented by a projection data block at at least one position in at least one dimension, and frequency trend information presented by a filtered projection data block that is obtained by filtering the projection data block by using at least two kernel functions of different frequencies. As an example, when the input features are constructed based on the projection data trend information and the frequency trend information, the projection data trend information and the frequency trend information may be respectively constructed as input channels of the input features. For example, when the trend information of the raw projection data includes the projection data trend information in the row direction and the channel direction shown in FIG. 5, the projection data trend information in the viewing angle direction shown in FIG. 6, and the frequency trend information shown in FIG. 7, the projection data trend information in the row direction and the channel direction may be constructed as a first input channel of the input features, the projection data trend information in the viewing angle direction may be constructed as a second input channel of the input features, and the frequency trend information may be constructed as a third input channel, a fourth input channel, and a fifth input channel of the input features in the order of increasing or decreasing cut-off frequency of the kernel functions. It should be understood that the above is only one example of constructing the input features, and the input features may be constructed using one or more of the above trend information as required, and the positions of different trend information in the input features may be adjusted as required.

In an embodiment, the projection data block may include raw projection data within a plane formed by two other dimensions at a position in one dimension of the at least one dimension of the raw projection data. For example, the projection data block may include raw projection data within a plane formed by the row direction and the channel direction at a viewing angle position in the viewing angle direction. Additionally or alternatively, the projection data block may include raw projection data within a plane formed by the viewing angle direction and the channel direction at a row position in the row direction. Additionally or alternatively, the projection data block may include raw projection data within a plane formed by the row direction and the viewing angle direction at a channel position in the channel direction.

Accordingly, in the present disclosure, one or more pieces of trend information are fully exploited based on projection data, and inherent rules of various trend information are used to achieve improved image resolution enhancement.

FIG. 8 shows a method for performing batch processing within a channel-row plane (i.e., within a certain viewing angle range) according to an embodiment of the present disclosure. Since there is an upper limit to the size of data that can be processed each time during processing of image data, it is necessary to extract a plurality of small-sized data blocks from complete large-sized three-dimensional projection data acquired from a subject under examination by a detector of a medical imaging system, and then each small-sized data block is processed in turn. For example, as shown in FIG. 8, projection data on the right side corresponds to the top box on the left side, that is, corresponds to a certain viewing angle. First, a first data block corresponding to a black solid-line box is extracted, and the first data block is processed with reference to the method 400 of FIG. 4. Then, a second data block corresponding to a black dashed-line box is extracted, and the second data block is processed with reference to the method 400 of FIG. 4. Next, a third data block corresponding to a black dotted-line box is extracted, and the third data block is processed with reference to the method 400 of FIG. 4, and so on, until all the projection data on the right side of FIG. 8 is traversed. The size of a data block may be adjusted as required. A first interval between the first data block and the second data block and a second interval between the second data block and the third data block may be the same or different, and the first interval and the second interval may be adjusted as required. Although FIG. 8 shows that the first data block and second data block overlap and the second data block and third data block overlap, the first data block, the second data block, and third data block may also be non-overlapping. If the extracted data blocks can cover the entire range on the right side of FIG. 8, trend information in a channel-row plane at this viewing angle can be fully exploited. In addition, data in a row-channel plane corresponding to each viewing angle of the raw projection data may be processed in the same manner, in order to fully exploit trend information of the entire raw projection data. It should be understood that although FIG. 8 only shows batch processing within a channel-row plane, the method is also applicable to a row-viewing angle plane and a channel-viewing angle plane.

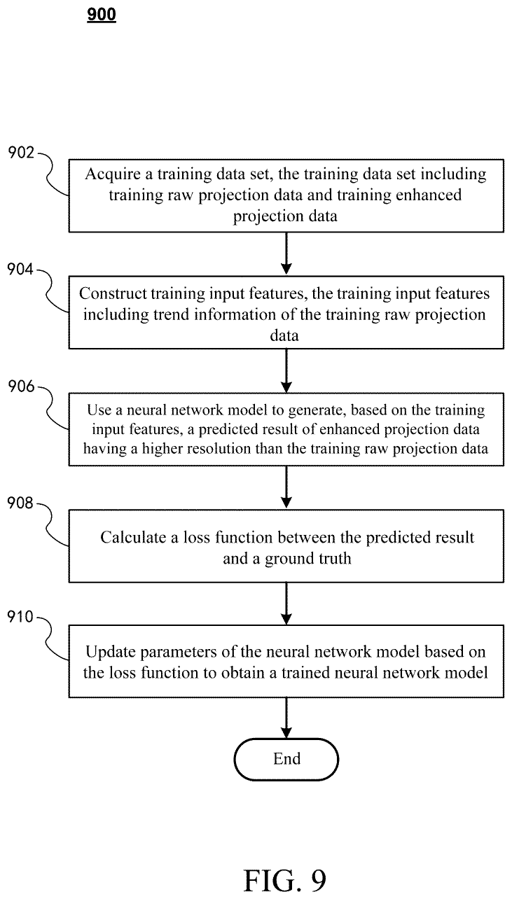

FIG. 9 shows a flowchart of a method 900 for training a neural network model according to an embodiment of the present disclosure.

In step 902, a training data set is acquired, the training data set including training raw projection data and training enhanced projection data. The training raw projection data and the training enhanced projection data can each be used to reconstruct a medical image of the subject under examination. The training enhanced projection data has a higher resolution than the training raw projection data, and the training enhanced projection data is used as a ground truth for an output of a neural network model.

The training data set may be obtained from high-resolution reconstructed images, such as high-resolution reconstructed images obtained by means of micro computed tomography (Micro-CT). The high-resolution reconstructed images are converted into projection data, i.e., high-resolution projection data, and then the high-resolution projection data is downsampled to obtain low-resolution projection data. Accordingly, the low-resolution projection data can be used as training raw data in the training data set, while the high-resolution projection data may be used as the training enhanced projection data in the training data set.

In step 904, training input features are constructed, the training input features including trend information of the training raw projection data;

In an embodiment, the training raw projection data is three-dimensional projection data acquired by a detector of the medical imaging system and includes three dimensions: a row direction, a channel direction, and a viewing angle direction, the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the training raw projection data at each of different positions around the subject under examination.

In an embodiment, the trend information of the training raw projection data includes one or more of the following: projection data trend information in at least one dimension; and frequency trend information in a specific order obtained by filtering training raw projection data at at least one position in the at least one dimension by using at least two kernel functions of different frequencies.

In an embodiment, in step 904, constructing the training input features includes: constructing the trend information of the training raw projection data as input channels of the training input features.

The process of constructing the training input features in step 904 is similar to the process of constructing the input features in step 404. To avoid redundancy, specific details are not repeated herein.

In step 906, the neural network model is used to generate, based on the training input features, a predicted result of enhanced projection data having a higher resolution than the training raw projection data. The neural network model may employ any suitable resolution enhancement model.

In step 908, a loss function between the predicted result and the ground truth is calculated.

In an embodiment, the loss function includes at least one of the following: a mean absolute error loss function, a mean structural similarity index measure loss function, and a perceptual loss function. A weighted sum of different loss functions may be used as a total loss function.

The mean absolute error loss function LOSS_{MAE} can be used to calculate losses pixel by pixel, and the calculation formula is as follows:

$${Loss}_{MAE} = \vert {I}_{predict} - {I}_{gt} \vert$$

I_{predict} represents the value of a predicted result of a pixel, and I_{gt} represents a ground truth of the pixel.

The mean structural similarity index measure (SSIM) loss function Loss_{SSIM} may be used to calculate block-by-block similarity. Due to the high requirement for structural fidelity in medical images, it is necessary to ensure not only improved visual sharpness of the images, but also unchanged tissue structures in the images. Therefore, this loss function helps ensure the consistency between the images and real tissue structures. The calculation formula is as follows:

$${Loss}_{SSIM} ( {I}_{predict} , {I}_{gt} ) = \frac{( 2 {μ}_{predict} {μ}_{gt} + {c}_{1} ) ( 2 {σ}_{predict , gt} + {c}_{2} )}{( {μ}_{predict}^{2} + {μ}_{gt}^{2} + {c}_{1} ) ( {σ}_{predict}^{2} + {σ}_{gt}^{2} + {c}_{2} )}$$

μ_{predict} and μ_{gt} are respectively the means of the predicted result and the ground truth,

$${σ}_{predict}^{2} and {σ}_{gt}^{2}$$

are respectively the variances of the predicted result and the ground truth, σ_{predict,gt} is the covariance between the predicted result and the ground truth, and c₁ and c₂ are small constants.

The perceptual loss function Loss_{Perceptual} can be used to evaluate semantic similarity. Since this loss function can evaluate similarity in high-level feature domains, robustness can be improved in terms of noise elimination. For example, a VGG19 relu5_4 layer may be used, and the calculation formula is as follows:

$${Loss}_{Perceptual} = {‖ vgg 19 ( {I}_{predict} ) - vgg 19 ( {I}_{gt} ) ‖}_{2}$$

In the present disclosure, structural similarity and/or semantic similarity can be further improved by improving the loss functions, thereby improving the fidelity and robustness of resolution-enhanced results.

In step 910, parameters of the neural network model are updated based on the loss function to obtain a trained neural network model.

Accordingly, in the present disclosure, the neural network model is trained based on one or more pieces of trend information of the projection data, so that the neural network model can achieve improved image resolution enhancement.

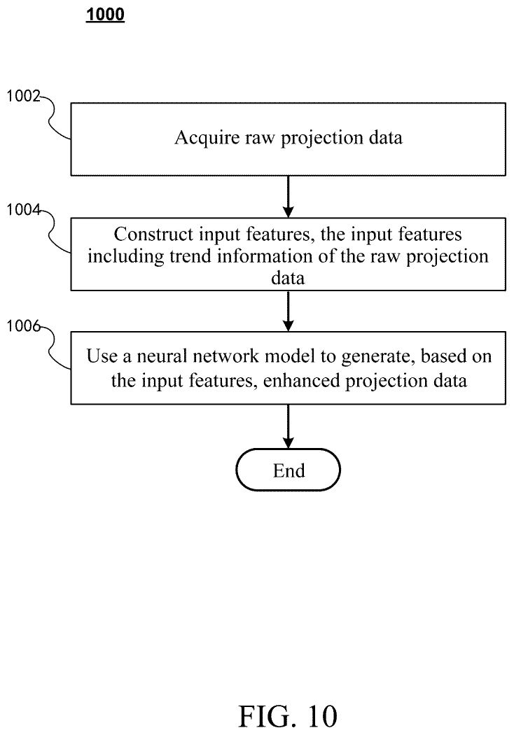

FIG. 10 shows a flowchart of a method 1000 for image processing according to another embodiment of the present disclosure. To improve the resolution of image data, the present disclosure further provides a method 1000 which uses an improved neural network model, and the structure of the neural network model is described in detail below. In step 1002, raw projection data is acquired. The raw projection data is acquired by scanning a subject under examination by means of a medical imaging system. Next, in step 1004, input features are constructed, the input features including trend information of the raw projection data. Then, in step 1006, a neural network model is used to generate enhanced projection data based on the input features, wherein the enhanced image data has a higher resolution than the raw image data.

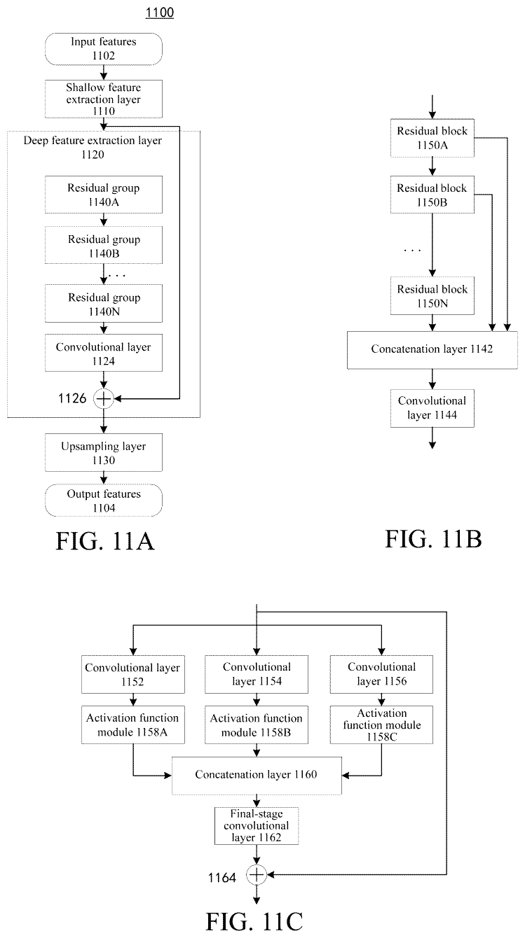

FIG. 11A shows a schematic diagram of a neural network model 1100 according to an embodiment of the present disclosure. In an embodiment, the neural network model 1100 may employ a residual channel attention network (RCAN). The neural network model 1100 may receive trend information of raw projection data acquired by scanning a subject under examination by means of a medical imaging system, uses the trend information as input features 1102, and outputs enhanced projection data, wherein the enhanced projection data has a higher resolution than the raw projection data. The neural network model 1100 includes a shallow feature extraction layer 1110, a deep feature extraction layer 1120, and an upsampling layer 1130. The shallow feature extraction layer 1110 may include a convolutional layer, for example, a two-dimensional convolutional layer. The shallow feature extraction layer 1110 is configured to perform feature extraction on the input features 1102 to obtain shallow features. The deep feature extraction layer 1120 may include at least one residual group 1140A, 1140B, . . . , and 1140N, a convolutional layer 1124, and a summation module 1126 that are cascaded, and is configured to perform feature extraction on the shallow features from the shallow feature extraction layer 1110 to obtain deep features. The upsampling layer 1130 may upsample the deep features from the deep feature extraction layer 1120 to obtain output features 1104 of a desired resolution to serve as the enhanced projection data. For example, the upsampling layer 1130 may include a pixel shuffle layer and a convolutional layer.

In an embodiment, the raw projection data is three-dimensional projection data acquired by a detector of the medical imaging system and includes three dimensions: a row direction, a channel direction, and a viewing angle direction, the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the raw projection data at each of different positions around the subject under examination.

In an embodiment, the trend information of the raw projection data includes one or more of the following: projection data trend information in at least one dimension; and frequency trend information in a specific order obtained by filtering raw projection data at at least one position in the at least one dimension by using at least two kernel functions of different frequencies.

FIG. 11B shows a schematic diagram of a residual group according to an embodiment of the present disclosure. A residual group may include a plurality of cascaded residual blocks 1150A, 1150B, . . . , and 1150N, a concatenation layer 1142, and a convolutional layer 1144. Each of the residual blocks 1150A, 1150B, . . . , and 1150N may extract deep features of a different level from an input of the residual group. The concatenation layer 1142 may concatenate deep features extracted by all the residual blocks to obtain concatenated deep features. The convolutional layer 1144 may perform a convolution operation on the concatenated deep features to obtain an output of the residual group. In the conventional residual group structure of the RCAN network, no concatenation layer is present, while in the present disclosure, by innovatively introducing the concatenation layer after the residual blocks, deep features at different levels can be concatenated to implement fusion of different deep features, thereby retaining information details across different depths and improving the resolution of an output image.

FIG. 11C shows a schematic diagram of a residual block according to an embodiment of the present disclosure. A residual block includes a plurality of parallel convolutional layers 1152, 1154, and 1156 of different sizes, activation function modules 1158A, 1158B, and 1158C each cascaded with one of the convolutional layers, a concatenation layer 1160, a final-stage convolutional layer 1162, and a summation module 1164. Each of the convolutional layers 1152, 1154, and 1156 is configured to perform a convolution operation on an input of the residual block to obtain a convolution result. The convolutional layers 1152, 1154, and 1156 use convolutional kernels of different sizes, for example, the convolutional layer 1152 uses a convolutional kernel of a size of 1×1, the convolutional layer 1154 uses a convolutional kernel of a size of 3×3, and the convolutional layer 1156 uses a convolutional kernel of a size of 5×5, thereby implementing multi-scale feature extraction by introducing receptive fields of different sizes. The activation function modules 1158A, 1158B, and 1158C each are cascaded with one of the convolutional layers 1152, 1154, and 1156, and each are configured to apply an activation function to a convolution result of the corresponding convolutional layer to obtain a local feature. The activation function modules 1158A, 1158B, and 1158C may employ a leaky rectified linear unit (Leaky ReLU) layer. One convolutional layer and one activation function module form one sub-branch of the residual block, wherein the convolutional layer 1152 and the activation function module 1158A form a first sub-branch, the convolutional layer 1154 and the activation function module 1158B form a second sub-branch, and the convolutional layer 1156 and the activation function module 1158C form a third sub-branch. Although FIG. 11C shows only three sub-branches, it should be understood that the quantity of sub-branches may be set as required, and the size of the convolutional layer may also be selected as required, without being limited to the example of FIG. 11C. The concatenation layer 1160 may concatenate the local features generated by the activation function modules 1158A, 1158B, and 1158C to obtain concatenated local features. The final-stage convolutional layer 1162 may perform a convolution operation on the concatenated local features to obtain a final-stage convolution result. The summation module 1164 may add the final-stage convolution result to the input of the residual block to obtain an output of the residual block.

Therefore, the neural network model proposed by the present disclosure can fuse different depth features of projection data, so that the output projection data has richer details and improved resolution.

In an embodiment, the neural network model 1100 may also be applied to the neural network model in the method 400.

The neural network model 1100 may be trained through the following steps. First, a training data set is acquired, the training data set including training raw projection data and training enhanced projection data, wherein the training enhanced projection data has a higher resolution than the training raw projection data, and the training enhanced projection data is used as a ground truth for an output of the neural network model. Second, training input features are constructed based on trend information of the training raw projection data. Next, a neural network model is used to generate, based on the training input features, a predicted result of enhanced projection data having a higher resolution than the training raw projection data. Then, a loss function between the predicted result and the ground truth is calculated. Finally, parameters of the neural network model are updated based on the loss function to obtain a trained neural network model.

In an embodiment, the loss function includes at least one of the following: a mean absolute error loss function, a mean structural similarity index measure loss function, and a perceptual loss function. A weighted sum of different loss functions may be used as a total loss function.

In addition, the present disclosure further provides a medical imaging system, including: a scanning device, configured to acquire raw projection data of a subject under examination; and a processor, configured to perform any one of the methods 400, 900, and 1000.

In addition, the present disclosure further provides a non-transient computer-readable medium having instructions stored thereon, wherein the instructions are executable by a processor to implement any one of the methods 400, 900, and 1000.

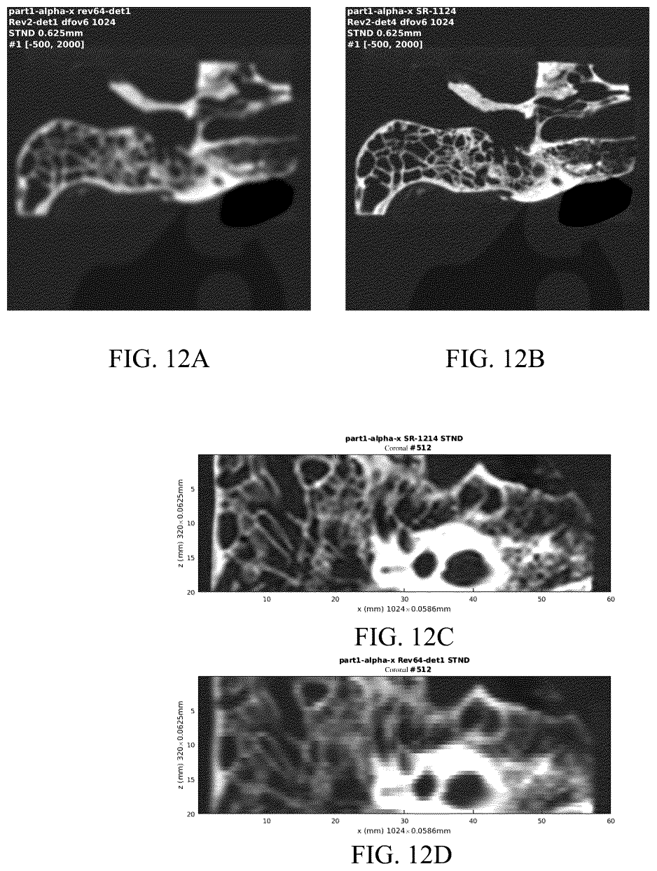

FIG. 12A and FIG. 12C show reconstructed images generated from raw projection data, whereas FIG. 12B and FIG. 12D show reconstructed images generated from the enhanced projection data obtained using the present disclosure. It can be learned from the comparison between FIG. 12A and FIG. 12B and the comparison between FIG. 12C and FIG. 12D that the reconstructed images generated based on the enhanced projection data obtained using the present disclosure have improved sharpness and are free of defects such as artifacts.

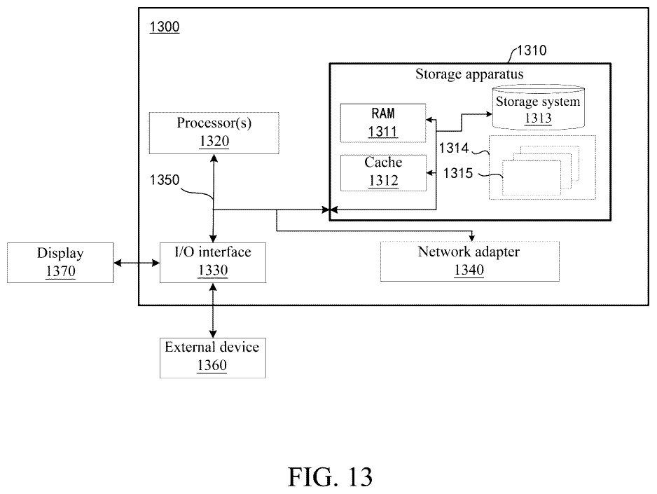

FIG. 13 shows an exemplary block diagram of a computing device 1300 according to an embodiment of the present disclosure. The computing device 1300 may be implemented as an example of the computing device 216 shown in FIG. 2. The computing device 1300 includes: one or more processors 1320; and a storage apparatus 1310, configured to store one or more programs, wherein the one or more programs, when executed by the one or more processors 1320, cause the one or more processors 1320 to implement the processes described in the present disclosure. The processor is, for example, a digital signal processor (DSP), a microcontroller, an application-specific integrated circuit (ASIC), or a microprocessor.

The computing device 1300 shown in FIG. 13 is merely an example, and should not impose any limitation to the function and usage scope of the embodiments of the present invention.

As shown in FIG. 13, the computing device 1300 is represented in the form of a general-purpose computing device. Components of the computing device 1300 may include, but are not limited to: one or more processors 1320, a storage apparatus 1310, and a bus 1350 connecting different system components (including the storage apparatus 1310 and the processor 1320).

The bus 1350 represents one or more of several types of bus structures, including a memory bus or a memory controller, a peripheral bus, an accelerated graphics port, a processor, or a local bus using any of the plurality of bus structures. For example, these architectures include, but are not limited to, an Industrial Standard Architecture (ISA) bus, a Micro Channel Architecture (MAC) bus, an enhanced ISA bus, a Video Electronics Standards Association (VESA) local bus, and a Peripheral Component Interconnect (PCI) bus.

The computing device 1300 typically includes a plurality of computer system-readable media. These media may be any available media that can be accessed by the computing device 1300, including volatile and non-volatile media as well as removable and non-removable media.

The storage apparatus 1310 may include a computer system-readable medium in the form of a volatile memory, such as a random access memory (RAM) 1311 and/or a cache memory 1312. The computing device 1300 may further include other removable/non-removable, and volatile/non-volatile computer system storage media. Only as an example, a storage system 1313 may be configured to read/write a non-removable, non-volatile magnetic medium (not shown in FIG. 13, typically referred to as a “hard disk drive”). Although not shown in FIG. 13, a magnetic disk drive configured to read/write a removable non-volatile magnetic disk (for example, a “floppy disk”) and an optical disc drive configured to read/write a removable non-volatile optical disc (for example, a CD-ROM, a DVD-ROM, or other optical media) may be provided. In these cases, each drive may be connected to the bus 1350 by means of one or more data medium interfaces. The storage apparatus 1310 may include at least one program product which has a group of program modules (for example, at least one program module) configured to perform the functions of the embodiments of the present invention.

A program/utility tool 1314 having a set of (at least one) program modules 1315 may be stored in, for example, the storage apparatus 1310. Such program modules 1315 include, but are not limited to, an operating system, one or more applications, other program modules, and program data, and each of these examples or a certain combination thereof may include an implementation of a network environment. The program modules 1315 typically perform the function and/or method in any embodiment described in the present invention.

The computing device 1300 may also communicate with one or more external devices 1360 (such as a keyboard, a pointing device, and a display 1370), and may also communicate with one or more devices that enable a user to interact with the computing device 1300, and/or communicate with any device (such as a network card and a modem) that enables the computing device 1300 to communicate with one or more other computing devices. Such communication may be carried out by means of an input/output (I/O) interface 1330. Moreover, the computing device 1300 may also communicate, by means of a network adapter 1340, with one or more networks (for example, a local area network (LAN), a wide area network (WAN), and/or a public network, for example, the Internet). As shown in FIG. 13, the network adapter 1340 communicates with other modules of the computing device 1300 by means of the bus 1350. It should be understood that although not shown in the figure, other hardware and/or software modules can be used in combination with the computing device 1300, including, but not limited to: microcode, device drivers, redundant processing units, external disk drive arrays, RAID systems, tape drives, data backup storage systems, and the like.

The processor 1320, by running programs stored in the storage apparatus 1310, implements various functional applications and data processing, such as implementing the processes described in the present disclosure.

The technique described herein may be implemented with hardware, software, firmware, or any combination thereof, unless specifically described as being implemented in a specific manner. Any features described as modules or components may also be implemented together in an integrated logical device, or separately implemented as discrete but interoperable logical devices. If implemented with software, the technique may be implemented at least in part by a non-transitory processor-readable storage medium that includes instructions, wherein when executed, the instructions perform one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or more aspects of at least some embodiments may be implemented by representative instructions that are stored in a machine-readable medium and represent various logic in a processor, wherein when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An example communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In one example, the network interface device may include one or more physical jacks (for example, Ethernet, coaxial, or phone jacks) or one or more antennas for connection to the communication network. In one example, the network interface device may include a plurality of antennas that wirelessly communicate using at least one of single-input multiple-output (SIMO), multiple-input multiple-output (MIMO), and multiple-input single-output (MISO) technology.

The term “transmission medium” should be considered to include any intangible medium capable of storing, encoding, or carrying instructions for execution by a machine, and the “transmission medium” includes digital or analog communication signals or any other intangible medium for facilitating communication of such software.

Thus far, the image processing method and system, the neural network model training method, and the medical imaging system according to the present invention have been described, and a computer-readable storage medium capable of implementing the methods has also been described.

Some exemplary embodiments have been described above. However, it should be understood that various modifications can be made to the exemplary embodiments described above without departing from the spirit and scope of the present invention. For example, an appropriate result can be achieved if the described techniques are performed in a different order and/or if the components of the described system, architecture, device, or circuit are combined in other manners and/or replaced or supplemented with additional components or equivalents thereof; accordingly, the modified other implementations also fall within the protection scope of the claims.

1. A method for image processing, comprising:
acquiring raw projection data of a subject under examination, wherein the raw projection data is acquired by scanning the subject under examination by means of a medical imaging system;
constructing input features, the input features including trend information of the raw projection data; and
using a neural network model to generate enhanced projection data of the subject under examination based on the input features, wherein the enhanced projection data has a higher resolution than the raw projection data and is used to reconstruct a medical image of the subject under examination.

2. The method according to claim 1, wherein the raw projection data is three-dimensional projection data acquired by a detector of the medical imaging system and includes a row direction, a channel direction, and a viewing angle direction, wherein the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the raw projection data at each of different positions around the subject under examination.

3. The method according to claim 2, wherein the trend information of the raw projection data includes one or more of the following:
projection data trend information in at least one dimension; and
frequency trend information in a specific order obtained by filtering raw projection data at at least one position in the at least one dimension by using at least two kernel functions of different frequencies.

4. The method according to claim 3, wherein the trend information of the raw projection data includes projection data trend information presented by a projection data block at at least one position in the at least one dimension, and frequency trend information presented by a filtered projection data block that is obtained by filtering the projection data block by using at least two kernel functions of different frequencies.

5. The method according to claim 4, wherein the projection data block includes raw projection data within a plane formed by two other dimensions at a position in one dimension of the at least one dimension of the raw projection data.

6. The method according to claim 1, wherein constructing input features includes:
constructing the trend information of the raw projection data as input channels of the input features.

7. The method according to claim 2, wherein the medical imaging system is a computed tomography (CT) medical imaging system, a positron emission tomography-computed tomography (PET-CT) medical imaging system, or a positron emission tomography (PET) medical imaging system.

8. A method for training a neural network model, comprising:
acquiring a training data set, the training data set including training raw projection data and training enhanced projection data, wherein the training raw projection data and the training enhanced projection data each are usable for reconstructing a medical image of a subject under examination, the training enhanced projection data has a higher resolution than the training raw projection data, and the training enhanced projection data is used as a ground truth for an output of the neural network model;
constructing training input features, the training input features including trend information of the training raw projection data;
using the neural network model to generate, based on the training input features, a predicted result of enhanced projection data having a higher resolution than the training raw projection data;
calculating a loss function between the predicted result and the ground truth; and
updating parameters of the neural network model based on the loss function to obtain a trained neural network model.

9. The method according to claim 8, wherein the training raw projection data is three-dimensional projection data acquired by a detector of the medical imaging system and includes: a row direction, a channel direction, and a viewing angle direction, wherein the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the training raw projection data at each of different positions around the subject under examination.

10. The method according to claim 9, wherein the trend information of the training raw projection data includes one or more of the following:
projection data trend information in at least one dimension; and
frequency trend information in a specific order obtained by filtering training raw projection data at at least one position in the at least one dimension by using at least two kernel functions of different frequencies.

11. The method according to claim 8, wherein constructing training input features includes:
constructing the trend information of the training raw projection data as input channels of the training input features.

12. The method according to claim 8, wherein the loss function includes at least one of the following: a mean absolute error loss function, a mean structural similarity index measure loss function, and a perceptual loss function.

13. A system for image processing, including a neural network model, comprising:
an X-ray source;
a detector; and
a processor, wherein the processor includes:
a neural network model that receives trend information of raw projection data acquired by scanning a subject under examination by means of a medical imaging system, uses the trend information as input features, and outputs enhanced projection data, wherein the enhanced projection data has a higher resolution than the raw projection data; and
wherein the neural network model includes:
a shallow feature extraction layer, configured to perform feature extraction on the input features by using a convolutional layer, so as to obtain shallow features;
a deep feature extraction layer, configured to perform feature extraction on the shallow features by using at least one residual group, a convolutional layer, and a summation module that are cascaded, so as to obtain deep features; and
an upsampling layer, configured to upsample the deep features into the enhanced projection data.

14. The system according to claim 13, wherein each residual group of the deep feature extraction layer includes:
a plurality of cascaded residual blocks, each residual block being configured to extract deep features of a different level from an input of the residual group;
a concatenation layer, configured to concatenate deep features extracted by all the residual blocks to obtain concatenated deep features; and
a convolutional layer, configured to perform a convolution operation on the concatenated deep features to obtain an output of the residual group.

15. The system according to claim 14, wherein each residual block includes:
a plurality of parallel convolutional layers of different sizes, each convolutional layer being configured to perform a convolution operation on an input of the residual block to obtain a convolution result;
a plurality of activation function modules, each activation function module being cascaded with one of the plurality of parallel convolutional layers of different sizes, and configured to apply an activation function to a convolution result of the corresponding convolutional layer to obtain a local feature;
a concatenation layer, configured to concatenate local features of the activation function modules to obtain concatenated local features;
a final-stage convolutional layer, configured to perform a convolution operation on the concatenated local features to obtain a final-stage convolution result; and
a summation module, configured to add the final-stage convolution result to the input of the residual block to obtain an output of the residual block.

16. The system according to claim 13, wherein the raw projection data is three-dimensional projection data acquired by a detector of the medical imaging system and includes three dimensions: a row direction, a channel direction, and a viewing angle direction, the row direction indicates a direction of the detector in which the subject under examination moves toward or out of the medical imaging system, the channel direction indicates an extension direction of the detector arranged locally around the subject under examination, which is perpendicular to the row direction, and the viewing angle direction indicates an angle at which the detector acquires the raw projection data at each of different positions around the subject under examination.

17. The system according to claim 16, wherein the trend information of the raw projection data includes one or more of the following:
projection data trend information in at least one dimension; and
frequency trend information in a specific order obtained by filtering raw projection data at at least one position in the at least one dimension by using at least two kernel functions of different frequencies.
